(19) United States
(12) Patent Application Publication
(10) Pub. No.: US 2026/0278878 A1
(43) Pub. Date: Sep. 17, 2026

(54) IMAGE GENERATION METHODS, APPARATUS, AND NON-TRANSITORY COMPUTER-READABLE STORAGE MEDIA

(71) Applicant: Beijing Zitiao Network Technology Co., Ltd., Beijing (CN)

(72) Inventor: Zijian ZHANG, Beijing (CN)

(21) Appl. No.: 19/469,360

(22) PCT Filed: Jul. 30, 2024
(86) PCT No.: PCT/CN2024/108339

§ 371 Date: Sep. 25, 2025

(30) Foreign Application Priority Data
Nov. 27, 2023 (CN) 202311597187.3

(51) Int. Cl. G06T 11/60

(52) U.S. Cl. CPC G06T 11/60

(57) ABSTRACT

The present disclosure relates to an image generation method, apparatus and non-transitory computer-readable storage medium, and relates to the technical field of computers. The image generation method includes: receiving a first set of attribute information of a virtual object input by a user; generating a relevant image of the virtual object based on the first set of attribute information and an object template, where the object template matches the first set of attribute information and is configured to determine at least one of pose information and image composition information of the virtual object in the relevant image.

### CROSS-REFERENCE TO RELATED APPLICATIONS

The present disclosure is based on and claims priority of Chinese Application No. 202311597187.3, filed on Nov. 27, 2023, which is hereby incorporated into this disclosure by reference in its entirety.

### TECHNICAL FIELD

This disclosure relates to the field of computer technology, particularly to an image generation method, an image generation apparatus, and a non-transitory computer-readable storage medium.

### BACKGROUND

In computer applications such as games and interactive stories, it is usually necessary to visually represent virtual objects such as characters and scenes by means of artistic resources such as images, e.g., character illustrations, background images, etc.

In related arts, producers of interactive multimedia content must provide professional artists with specific image generation requirements and rely on manual guidance to draw appropriate artistic resources.

### SUMMARY

According to some embodiments of this disclosure, there is provided an image generation method, including: receiving a first set of attribute information of a virtual object input by a user; and generating a relevant image of the virtual object based on the first set of attribute information and an object template, where the object template matches the first set of attribute information and is configured to determine at least one of pose information and composition information of the virtual object in the relevant image.

In some embodiments, the object template is prioritized over the first set of attribute information, in response to a conflict between the first set of attribute information and the object template.

In some embodiments, the generating the relevant image of the virtual object based on the first set of attribute information and the object template includes: masking attribute information, in response to the attribute information conflicting with the object template in the first set of attribute information; and generating the relevant image based on a masking result and the object template.

In some embodiments, the generating the relevant image of the virtual object based on the first set of attribute information and the object template includes: generating the relevant image based on first attribute information, the object template and a second set of attribute information stored, where the second set of attribute information is configured to indicate a designated requirement for the relevant image, and the second set of attribute information is prioritized over the first set of attribute information, in response to a conflict between the first set of attribute information and the second set of attribute information.

In some embodiments, the second set of attribute information includes negative attribute information, and the generating the relevant image based on the first attribute information, the object template and the second set of attribute information stored includes: masking attribute information, in response to the attribute information conflicting with the negative attribute information in the first set of attribute information; and generating the relevant image based on a masking result and the second set of attribute information.

In some embodiments, the second set of attribute information includes positive attribute information configured to improve image quality of the relevant image.

In some embodiments, the second set of attribute information is invisible to the user.

In some embodiments, the second set of attribute information is configured to indicate an image style type of the relevant image.

In some embodiments, the generating the relevant image of the virtual object based on the first set of attribute information and the object template includes: generating the relevant image based on an image style type selected by the user.

In some embodiments, the generating the relevant image of the virtual object based on the first set of attribute information and the object template includes: generating a plurality of candidate images based on the first set of attribute information, where a resolution of the plurality of candidate images is lower than a threshold; and performing a super-resolution process on a selected candidate image in response to a user selection operation on the plurality of candidate images to generate the relevant image, where a resolution of the relevant image is higher than the resolution of the plurality of candidate images.

In some embodiments, the image generation method further includes: determining dynamic information of the virtual object in the relevant image based on content information corresponding to the relevant image, where the virtual object includes a character object; and generating, based on the dynamic information, a dynamic image of the character object by using a digital human model based on the relevant image.

In some embodiments, the generating, based on the dynamic information, the dynamic image of the character object by using the digital human model based on the relevant image includes: adjusting a facial angle of the character object in the relevant image based on the dynamic information; and generating the dynamic image based on an adjusted relevant image.

In some embodiments, the virtual object includes a character object, and the pose information is configured to indicate that a face of the character object in the relevant image is facing the user, with an eye of the character object directed toward the user.

In some embodiments, the generating the relevant image of the virtual object based on the first set of attribute information and the object template includes: determining the object template from a plurality of candidate object templates, in response to a user selection operation on the plurality of candidate object templates, where the plurality of candidate object templates match the first set of attribute information.

In some embodiments, the relevant image corresponds to a current frame image of interactive multimedia content, and the object template is selected based on content to be represented by the current frame image.

In some embodiments, the image generation method further includes: identifying a facial region of a character object in the relevant image, in response to the virtual object including the character object; and segmenting the relevant image based on the facial region to generate a head portrait of the character object.

In some embodiments, a portion of the relevant image other than the virtual object is transparent, and the image generation method further includes: fusing the relevant image with a background image to generate a frame image of interactive multimedia content.

In some embodiments, the image generation method further includes: segmenting an image region in which the virtual object is located from the relevant image; and fusing the image region with a background image to generate a frame image of interactive multimedia content.

In some embodiments, the virtual object includes a character object and a background object, and the composition information includes at least one of position information and size information of the virtual object in the relevant image.

According to other embodiments of this disclosure, there is provided an image generation apparatus, including: a receiving unit configured to receive a first set of attribute information of a virtual object input by a user; and a generating unit configured to generate a relevant image of the virtual object based on the first set of attribute information and an object template, where the object template matches the first set of attribute information and is configured to determine at least one of pose information and composition information of the virtual object in the relevant image.

In some embodiments, the object template is prioritized over the first set of attribute information, in response to a conflict between the first set of attribute information and the object template.

In some embodiments, the generating unit masks attribute information, in response to the attribute information conflicting with the object template in the first set of attribute information; and generates the relevant image based on a masking result and the object template.

In some embodiments, the generating unit generates the relevant image based on first attribute information, the object template and a second set of attribute information stored, where the second set of attribute information is configured to indicate a designated requirement for the relevant image, and the second set of attribute information is prioritized over the first set of attribute information, in response to a conflict between the first set of attribute information and the second set of attribute information.

In some embodiments, the second set of attribute information includes negative attribute information, and the generating unit masks attribute information, in response to the attribute information conflicting with the negative attribute information in the first set of attribute information; and generates the relevant image based on a masking result and the second set of attribute information.

In some embodiments, the second set of attribute information includes positive attribute information configured to improve image quality of the relevant image.

In some embodiments, the second set of attribute information is invisible to the user.

In some embodiments, the second set of attribute information is configured to indicate an image style type of the relevant image.

In some embodiments, the generating unit generates the relevant image based on an image style type selected by the user.

In some embodiments, the generating unit generates a plurality of candidate images based on the first set of attribute information, where a resolution of the plurality of candidate images is lower than a threshold; and performs a super-resolution process on a selected candidate image in response to a user selection operation on the plurality of candidate images to generate the relevant image, where a resolution of the relevant image is higher than the resolution of the plurality of candidate images.

In some embodiments, the generating unit determines dynamic information of the virtual object in the relevant image based on content information corresponding to the relevant image, where the virtual object includes a character object; and generates, based on the dynamic information, a dynamic image of the character object by using a digital human model based on the relevant image.

In some embodiments, the generating unit adjusts a facial angle of the character object in the relevant image based on the dynamic information; and generates the dynamic image based on an adjusted relevant image.

In some embodiments, the virtual object includes a character object, and the pose information is configured to indicate that a face of the character object in the relevant image is facing the user, with an eye of the character object directed toward the user.

In some embodiments, the generating unit determines the object template from a plurality of candidate object templates, in response to a user selection operation on the plurality of candidate object templates, where the plurality of candidate object templates match the first set of attribute information.

In some embodiments, the relevant image corresponds to a current frame image of interactive multimedia content, and the object template is selected based on content to be represented by the current frame image.

In some embodiments, the generating unit identifies a facial region of a character object in the relevant image, in response to the virtual object including the character object; and segments the relevant image based on the facial region to generate a head portrait of the character object.

In some embodiments, a portion of the relevant image other than the virtual object is transparent, and the generating unit fuses the relevant image with a background image to generate a frame image of interactive multimedia content.

In some embodiments, the generating unit segments an image region in which the virtual object is located from the relevant image; and fuses the image region with a background image to generate a frame image of interactive multimedia content.

In some embodiments, the virtual object includes a character object and a background object, and the composition information includes at least one of position information and size information of the virtual object in the relevant image.

According to some embodiments of this disclosure, there is provided an image generation apparatus, including: a memory; and a processor coupled to the memory, the processor configured to, based on instructions stored in the memory, perform an image generation method according to any one of the above embodiments.

According to still other embodiments of the present disclosure, there is provided a non-transitory computer readable storage medium stored thereon a computer program that, when executed by a processor, performs an image generation method according to any one of the above embodiments.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 shows a flowchart of an image generation method according to some embodiments of the present disclosure;

FIG. 2 shows a flowchart of an image generation method according to other embodiments of the present disclosure;

FIG. 3a shows a schematic diagram of an image generation method for a character object according to some embodiments of the present disclosure;

FIG. 3b shows a schematic diagram of an image generation method for a background object according to some embodiments of the present disclosure;

FIG. 3c shows a schematic diagram of a candidate image generation method according to some embodiments of the present disclosure;

FIG. 4 shows a block diagram of an image generation apparatus according to some embodiments of the present disclosure;

FIG. 5 shows a block diagram of an image generation apparatus according to other embodiments of the present disclosure;

FIG. 6 shows a block diagram of an image generation apparatus according to still other embodiments of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and values of the components and steps set forth in these embodiments do not limit the scope of the disclosure.

At the same time, it should be understood that, for ease of description, the dimensions of the various parts shown in the drawings are not drawn to actual proportions.

The following description of at least one exemplary embodiment is in fact merely illustrative and is in no way intended as a limitation to the disclosure, its application or use.

Techniques, methods, and devices known to those of ordinary skill in the relevant art may not be discussed in detail, but where appropriate, these techniques, methods, and devices should be considered as part of the specification.

Of all the examples shown and discussed herein, any specific value should be construed as merely illustrative and not as a limitation. Thus, other examples of exemplary embodiments may have different values.

Note that similar reference numerals and letters are denoted by the like in the accompanying drawings, and therefore, once an item is defined in a drawing, there is no need for further discussion in the accompanying drawings.

The inventors of the present disclosure have found the following problems existed in the related art: high time and labor costs, leading to a reduction in the efficiency and effectiveness of image generation.

In view of this, this disclosure proposes a technical solution for image generation that can improve the efficiency and effectiveness of image generation.

As mentioned above, manually drawing artistic resources in interactive multimedia content is time-consuming and labor-intensive, resulting in high time and labor costs, which reduces the efficiency and effectiveness of image generation.

In view of the above technical problems, this disclosure can formulate preset character poses and image compositions using preset object templates and, in conjunction with simple descriptive information provided by the user in an input box and with control of preset prompts, automatically generate images through machine learning models. Users can also select desired images from a plurality of generated images for super-resolution processing to generate character images or background images suitable for interactive multimedia content images.

By combining user-input attribute information with preset object templates, high-quality relevant images of the virtual object can be generated quickly, improving the efficiency and effectiveness of image generation. For example, the technical solution of the present disclosure can be realized by the following embodiments.

For example, the technical solution of the present disclosure can be realized by the following embodiments.

FIG. 1 shows a flowchart of an image generation method according to some embodiments of the present disclosure.

As shown in FIG. 1, in step 110, a first set of attribute information of a virtual object input by a user is received.

For example, the virtual object may include a character object, background object, etc. in interactive multimedia content. The interactive multimedia content can include games, interactive stories, interactive comics, interactive TV series, etc. The first set of attribute information may include a plurality of first attribute information configured to describe the characteristics of the virtual object.

In step 120, a relevant image of the virtual object is generated based on the first set of attribute information and an object template. The object template matches the first set of attribute information and is configured to determine at least one of pose information and composition information of the virtual object in the relevant image.

In the above embodiments, a relevant image of the virtual object is automatically generated by combining user-input attribute information with a preset object template. In this way, time and labor costs can be reduced, thereby improving the efficiency and effectiveness of image generation.

Below are some embodiments to exemplarily illustrate how to automatically generate a relevant image of a virtual object.

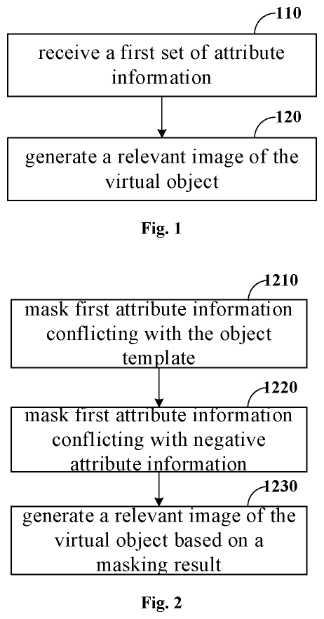

FIG. 2 shows a flowchart of an image generation method according to other embodiments of the present disclosure.

As shown in FIG. 2, a first set of attribute information input by a user can be used as a prompt and input into a machine learning model to automatically generate a relevant image of a virtual object. For example, a masking process may be performed on the first set of attribute information in steps 1210 to 1230, and then a machine learning model may be used to automatically generate a relevant image of the virtual object.

For example, the machine learning model may be a LLM (Large Language Model) that can generate image content based on a prompt provided by a user. In this way, the machine learning model can improve the efficiency and effectiveness of image generation.

In some embodiments, in response to a conflict between the first set of attribute information and the object template, the object template is prioritized over the first set of attribute information. For example, in step 1210, in response to first attribute information conflicting with the object template in the first set of attribute information, the first attribute information is masked.

For example, in response to the virtual object being a character object, the object template can be configured to determine pose information for the character object. For example, in a case where the first set of attribute information includes first attribute information “Character jumping up”, but the pose information defined by the object template includes “Character standing up”, “Character jumping up” is masked in the prompt and “Character standing up” is added to the prompt and then input into the machine learning model.

For example, in response to the virtual object being a background object, the object template can be configured to determine composition information of the background object. The composition information may include at least one of position information and size information of the virtual object in the relevant image. For example, in a case where the first set of attribute information includes first attribute information “A mountain located in the center of the image”, but the composition information defined by the object template includes “A mountain located in the upper left corner of the image”, “A mountain located in the center of the image” is masked in the prompt, and “A mountain located in the upper left corner of the image” is added to the prompt, and then input into the machine learning model.

In some embodiments, the object template matches the first set of attribute information. For example, the type or artistic style of the virtual object corresponding to the object template may match the type or artistic style of the virtual object corresponding to the first set of attribute information.

For example, in a case where the first set of attribute information describes a character object, the object template is a template for character objects; in a case where the first set of attribute information describes a background object, the object template is a template for background objects. For example, the character object described by the first set of attribute information is an ancient character, then the style of the object template is ancient style; the character object described by the first set of attribute information is a science fiction character, then the style of the object template is science fiction style.

In some embodiments, a relevant image is generated based on the first attribute information, the object template, and a second set of attribute information stored. For example, the second set of attribute information is configured to indicate designated requirements for the relevant image. In response to a conflict between the first set of attribute information and the second set of attribute information, the second set of attribute information is prioritized over the first set of attribute information.

For example, in step 1220, in response to the attribute information conflicting with the negative attribute information in the first set of attribute information, the first attribute information is masked.

In some embodiments, the second set of attribute information includes negative attribute information. For example, the negative attribute information refers to prompts that need to be masked, such as “Terrible hands” or “Nuked body parts”, which does not meet the designated requirements for image generation.

For example, in a case where the first set of attribute information includes first attribute information “Uniquely shaped hands” that conflicts with a negative prompt “Terrible hands” that needs to be masked, “Uniquely shaped hands” is masked in the prompt before the prompt is input into the machine learning model.

In some embodiments, the second set of attribute information includes positive attribute information configured to improve the image quality of the relevant image. For example, the positive attribute information can include “high quality”, “excellent work”, etc. This positive attribute information and the first attribute information provided by the user can be used together as a prompt to input into the machine learning model.

In some embodiments, the second set of attribute information is invisible to users. For example, the second set of attribute information includes negative attribute information and a prompt configured to indicate the image style type of the relevant image (e.g., Cyberpunk, Wuxia, Modern Urban, etc.). This information is hidden in the background and is invisible to the user, without the need for any user interaction, thereby improving the efficiency and quality of image generation.

In some embodiments, a relevant image can also be generated based on an image style type selected by the user. For example, the user selects a modern urban style, a relevant image can be generated based on an object template corresponding to the modern urban style. In this way, appropriate images can be generated based on the actual needs of the users, thereby improving the efficiency and quality of image generation.

In some embodiments, steps 1210 and 1220 may be executed in any order or may be executed in parallel. For example, after the masking process in steps 1210 and 1220, it may be determined that the prompt is “A smiling man wearing glasses, dressed in modern clothing”. This prompt can be input into a machine learning model to generate a relevant image.

For example, in step 1230, a relevant image is generated based on a masking result and an object template. The prompt subject to the masking process and the prompt can be input into a machine learning model. The machine learning model generates a relevant image based on the prompt and matching object template of the prompt.

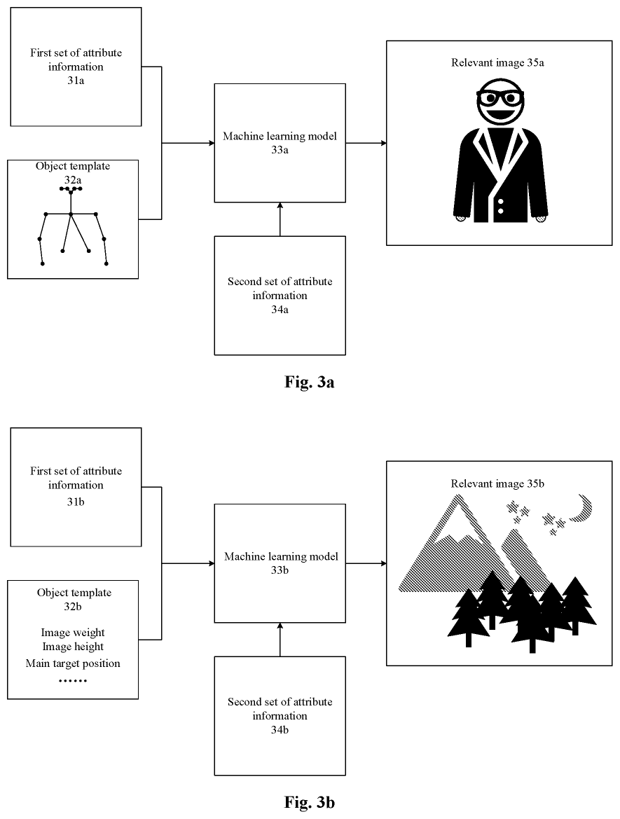

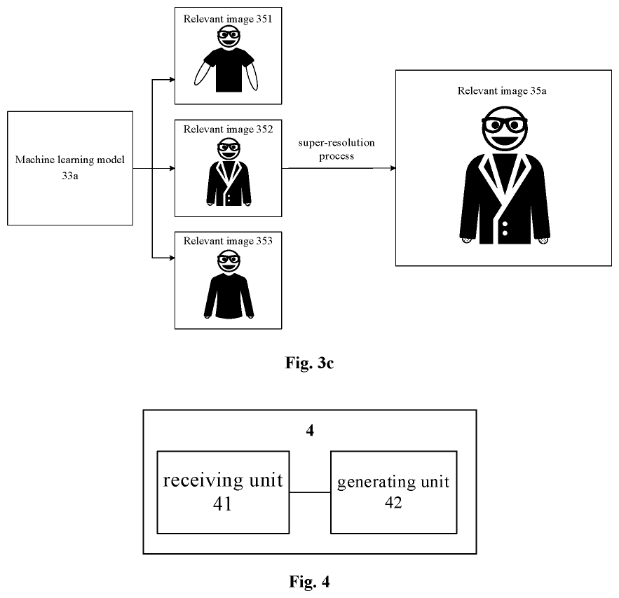

The following is an illustrative description of how to automatically generate a relevant image of a virtual object with reference to the embodiments shown in FIGS. 3a to 3c.

FIG. 3a shows a schematic diagram of an image generation method for a character object according to some embodiments of the present disclosure.

As shown in FIG. 3a, for example, a user wants to generate a relevant image of a virtual character object, the user can input first set of attribute information 31a including a plurality of first attribute information via an input box on a page. For example, the first set of attribute information 31a input by the user includes “a smiling man, wearing glasses, dressed in modern clothing, with four hands, jumping into the air”.

For example, it is determined based on the first set of attribute information 31a input by the user that the type of the virtual object is Character Object, then an object template 32a corresponding to Character Object can be automatically matched as the current object template. It is also possible to determine that the image style type is Modern Urban style based on the first set of attribute information 31a input by the user, and to automatically match an object template 32a corresponding to Modern Urban style as the current object template.

In some embodiments, in response to a user selection operation on a plurality of candidate object templates that match the first set of attribute information, an object template is determined from the plurality of candidate object templates. For example, the user can be provided with templates in various image style types to select from. It is also possible to automatically determine an image style type using a machine learning model based on the historical background and relevant plot of the interactive multimedia content in which the virtual character object is located, thereby improving the efficiency of image generation.

For example, object template 32a defines the pose information “Character standing up” of the character object, which conflicts with “jumping into the air” in the first set of attribute information 31a. In this case, “jumping into the air” is masked in the prompt and “Character standing up” is added to the prompt.

In this way, it is possible to automatically and effectively control prompts input by users through preset object templates, thereby improving the effectiveness of image generation.

For example, the first attribute information “four hands” in the first set of attribute information 31a conflicts with the negative prompt “terrible hands” that needs to be masked in the second set of attribute information 34a. In this case, “four hands” is masked in the prompt.

For example, the second set of attribute information 34a includes positive attribute information configured to improve the image quality of the relevant image. For example, the positive attribute information may include “high quality”, “excellent work”, etc. This positive attribute information and unmasked first attribute information can be added together to the prompt.

In this way, the second set of attribute information, hidden in the background, can automatically and effectively control the prompts input by the user, thereby improving the effectiveness of image generation.

For example, after the above masking and adding process on the first set of attribute information 31a, the prompt is “a high-quality image of a man wearing glasses, dressed in modern clothing, who is standing and smiling”. This prompt can be input into the machine learning model 33a. In this way, the machine learning model can generate a relevant image 35a of the character object based on the first set of attribute information 31a input by the user, under the control of the preset object template 32a and the second set of attribute information 34a.

FIG. 3b shows a schematic diagram of an image generation method for a background image according to some embodiments of the present disclosure.

As shown in FIG. 3b, for example, a user wants to generate a relevant image of a virtual background object, the user can input a first set of attribute information 31b including a plurality of first attribute information via an input box on a page. For example, the first set of attribute information 31b input by the user includes “Under the night sky, there is a forest in front of a mountain located in the center of the image”.

For example, it is determined based on the first set of attribute information 31b input by the user that the type of the virtual object is Background Object, then an object template 32b corresponding to Background Object can be automatically matched as the current object template. It is also possible to determine that the image style type is Modern style based on the first set of attribute information 31b input by the user, and to automatically match an object template 32b corresponding to the Modern style as the current object template.

For example, the user can also be provided with templates in various image style types to select from. It is also possible to automatically determine an image style type using a machine learning model based on the historical background and relevant plot of the interactive multimedia content in which the virtual background object is located, thereby improving the efficiency of image generation.

For example, the object template 32b can define size information such as the image width and image height of the generated image, as well as a main target position. In a case where the object template 32b defines that the main target position in the image is “located in the upper left corner of the image”, it conflicts with “a mountain located in the center of the image” in the first set of attribute information 31b. In this case, “a mountain located in the center of the image” is masked in the prompt and “a mountain located in the upper left corner of the image” is added to the prompt.

In this way, it is possible to automatically and effectively control prompts input by users through preset object templates, thereby improving the effectiveness of image generation.

For example, the second set of attribute information 34a includes positive attribute information configured to improve the image quality of the relevant image. For example, the positive attribute information may include “high quality”, “excellent work”, etc. This positive attribute information and unmasked first attribute information can be added together to the prompt.

In this way, the second set of attribute information, hidden in the background, can automatically and effectively control the prompts input by the user, thereby improving the effectiveness of image generation.

For example, after the above masking and adding process on the first set of attribute information 31b, the prompt is “a high-quality image of a forest in front of a mountain located in the upper left corner of the image under the night sky”. This prompt can be input into the machine learning model 33b. In this way, the machine learning model can generate a relevant image 35b of the background object based on the first set of attribute information 31b input by the user, under the control of the preset object template 32b and the second set of attribute information 34b.

In some embodiments, a plurality of candidate images are generated based on the first set of attribute information, where a resolution of the plurality of candidate images is lower than a threshold; a super-resolution process is performed on a selected candidate image in response to a user selection operation on the plurality of candidate images to generate the relevant image, where a resolution of the relevant image is higher than the resolution of the plurality of candidate images. For example, the technical solution for generating candidate images described above can be implemented by the embodiment in FIG. 3c.

FIG. 3c shows a schematic diagram of a candidate image generation method according to some embodiments of the present disclosure.

As shown in FIG. 3c, a user wants to generate a relevant image of a virtual character object, the user can input first set of attribute information including a plurality of first attribute information such as “a smiling man wearing glasses, dressed in modern clothing, and standing” via an input box on a page. A prompt corresponding to the first set of attribute information is input into a machine learning model 33a to generate low resolution relevant images 351, 352, and 353. In this way, the relevant images 351, 352, and 353 have a resolution lower than a threshold, thereby improving the efficiency of image generation.

As shown in FIG. 3b, all the relevant images 351, 352, and 353 meet the user's definition of “a smiling man wearing glasses, dressed in modern clothing, and standing” in the first set of attribute information, but there are differences among them. For example, the man in image 351 is wearing a short-sleeved T-shirt, the man in image 352 is wearing a suit, and the man in image 353 is wearing a long-sleeved T-shirt.

For example, the user can choose a desired image from the relevant images 351, 352, and 353. In response to the user selecting the relevant image 352, a super-resolution process (which may be implemented using an artificial intelligence algorithm) may be performed on the relevant image 352 to generate a relevant image 35a having a resolution higher than the threshold.

In this way, a plurality of low resolution candidate images can be quickly generated for the user to select from, and then the super-resolution process can be performed on the selected image of the users to obtain a desired high-quality image. In this way, the quality of the generated image is improved by making the generated image better meet actual needs, while improving the efficiency of image generation.

In some embodiments, based on content information corresponding to the relevant image, dynamic information of the virtual object in the relevant image is determined, where the virtual object includes a character object; based on the dynamic information, a dynamic image of the character object is generated by using a digital human model based on the relevant image.

For example, in a case where the virtual object is a character object in a game, there may be scenarios where the character object performs skills. In this case, corresponding action information can be generated as dynamic information based on the skills of the character object; based on the action information, a dynamic image of the character object performing the skills is generated based on the relevant image and combined with a digital human model.

For example, in a case where the virtual object is a character object, there may be a scenario where the character object speaks. In this case, corresponding lip movements can be generated as the dynamic information based on the dialogue lines of the character object, and a dynamic image of the character object speaking can be generated based on the relevant image according to the lip movements.

In some embodiments, the facial angles of the character object in the relevant image are adjusted based on the dynamic information; and a dynamic image is generated based on the adjusted relevant image. For example, the virtual object includes a character object, and the pose information is configured to indicate that the face of the character object in the relevant image is facing the user, with the eyes of the character object directed toward the user.

For example, in a scene where a character object is speaking, it is often necessary to orient the character's face towards the user off screen in order to clearly convey the intent of the speech of the character object. In this case, the facial angles of the character in the relevant image can be adjusted so that the adjusted face of the character is oriented towards the user as the relevant image 35a in FIG. 3a.

This ensures combination between the generated relevant image and digital human technology to generate the dynamic character image, thereby improving the quality of image generation.

In some embodiments, the relevant image corresponds to a current frame image of interactive multimedia content, and the object template is selected based on content to be represented by the current frame image.

For example, the virtual object is a character object in a game that includes multi-frame images, each configured to represent different plot content. For example, content to be represented by the current frame image of the game is a character object standing while speaking. In this case, an object template defined by a standing pose of the character and the face of the character object facing the user can be automatically matched.

In this way, an object template that matches the current content can be automatically matched, thereby improving the efficiency and quality of image generation.

In some embodiments, in response to the virtual object including a character object, a facial region of the character object is identified in the relevant image; and the relevant image is segmented based on the facial region to generate a head portrait of the character object.

For example, the virtual object is a character object in a game, it is necessary to generate a head portrait of the character object as an artistic resource in the game. In this case, by segmenting the head portrait from the generated relevant image of the character object, the efficiency and quality of artistic resource generation can be improved.

In some embodiments, a portion of the relevant image other than the virtual object is transparent. The relevant image is fused with a background image to generate a frame image of the interactive multimedia content. For example, the background portion of the relevant image 35a of the character object generated in FIG. 3a is transparent, and the relevant image 35a can be directly superimposed on a background image to generate a frame image meeting to a plot of the interactive multimedia content, thereby improving the efficiency and quality of image generation.

In some embodiments, an image region in which the virtual object is located is segmented from the relevant image; and the image region is fused with a background image to generate a frame image of the interactive multimedia content. For example, image segmentation process can be performed on the character object in the relevant image 35a to obtain a character image that only includes the character object; the character image can be directly superimposed on a background image to generate a frame image that meets to a plot of the interactive multimedia content, thereby improving the efficiency and quality of image generation.

In some embodiments, a machine learning model can be used to automatically generate a set of attribute information about a character based on prior knowledge such as the plot content and character setting of interactive multimedia content; and then a relevant image of the character is generated based on the set of attribute information.

For example, the user is the creator of a game, upon completing the setting of the game chapter and character summaries, an LLM can be used to understand prior knowledge such as the game's plot content, character settling and background settling, and automatically generate a first set of attribute information to describe the character's characteristics. Based on the first set of attribute information and in combination with preset character pose and image composition information, a relevant image is generated by applying control over image composition and prompt. This enables automated deployment of a text-to-image generation pipeline, thereby improving the efficiency and quality of image generation.

In some embodiments, in a case where the generated prompt is not in the user's familiar language, the user may directly modify the prompt using the user's familiar language. Using artificial intelligence technology, the prompt modified by the user can be automatically translated into the language of the original prompt. In this way, users are allowed to adjust the image generation using their familiar language, thereby improving the efficiency of image generation.

In the above embodiments, a machine learning model is used to automatically generate the relevant image of the virtual object in combination with attribute information input by users and a preset object template. This enables users to generate high-quality images that can meet requirements without artistic expertise, thereby reducing the time and labor costs of image generation while improving the efficiency and effectiveness of image generation.

FIG. 4 shows a block diagram of an image generation apparatus according to some embodiments of the present disclosure.

As shown in FIG. 4, the image generation apparatus 4 includes: a receiving unit 41 configured to receive a first set of attribute information of a virtual object input by a user; and a generating unit 42 configured to generate a relevant image of the virtual object based on the first set of attribute information and an object template, where the object template matches the first set of attribute information and is configured to determine at least one of pose information and composition information of the virtual object in the relevant image.

In some embodiments, the object template is prioritized over the first set of attribute information, in response to a conflict between the first set of attribute information and the object template.

In some embodiments, the generating unit 42 masks attribute information, in response to the attribute information conflicting with the object template in the first set of attribute information; and generates the relevant image based on a masking result and the object template.

In some embodiments, the generating unit 42 generates the relevant image based on first attribute information, the object template and a second set of attribute information stored, where the second set of attribute information is configured to indicate a designated requirement for the relevant image, and the second set of attribute information is prioritized over the first set of attribute information, in response to a conflict between the first set of attribute information and the second set of attribute information.

In some embodiments, the second set of attribute information includes negative attribute information, and the generating unit 42 masks attribute information, in response to the attribute information conflicting with the negative attribute information in the first set of attribute information; and generates the relevant image based on a masking result and the second set of attribute information.

In some embodiments, the second set of attribute information includes positive attribute information configured to improve image quality of the relevant image.

In some embodiments, the second set of attribute information is invisible to the user.

In some embodiments, the second set of attribute information is configured to indicate an image style type of the relevant image.

In some embodiments, the generating unit 42 generates the relevant image based on an image style type selected by the user.

In some embodiments, the generating unit 42 generates a plurality of candidate images based on the first set of attribute information, where a resolution of the plurality of candidate images is lower than a threshold; and performs a super-resolution process on a selected candidate image in response to a user selection operation on the plurality of candidate images to generate the relevant image, where a resolution of the relevant image is higher than the resolution of the plurality of candidate images.

In some embodiments, the generating unit 42 determines dynamic information of the virtual object in the relevant image based on content information corresponding to the relevant image, where the virtual object includes a character object; and generates, based on the dynamic information, a dynamic image of the character object by using a digital human model based on the relevant image.

In some embodiments, the generating unit 42 adjusts a facial angle of the character object in the relevant image based on the dynamic information; and generates the dynamic image based on an adjusted relevant image.

In some embodiments, the virtual object includes a character object, and the pose information is configured to indicate that a face of the character object in the relevant image is facing the user, with an eye of the character object directed toward the user.

In some embodiments, the generating unit 42 determines the object template from a plurality of candidate object templates, in response to a user selection operation on the plurality of candidate object templates, where the plurality of candidate object templates match the first set of attribute information.

In some embodiments, the relevant image corresponds to a current frame image of interactive multimedia content, and the object template is selected based on content to be represented by the current frame image.

In some embodiments, the generating unit 42 identifies a facial region of a character object in the relevant image, in response to the virtual object including the character object; and segments the relevant image based on the facial region to generate a head portrait of the character object.

In some embodiments, a portion of the relevant image other than the virtual object is transparent, and the generating unit 42 is fuses the relevant image with a background image to generate a frame image of interactive multimedia content.

In some embodiments, the generating unit 42 segments an image region in which the virtual object is located from the relevant image; and fuses the image region with a background image to generate a frame image of interactive multimedia content.

In some embodiments, the virtual object includes a character object and a background object, and the composition information includes at least one of position information and size information of the virtual object in the relevant image.

In the above embodiments, a relevant image of the virtual object is automatically generated by combining user-input attribute information with a preset object template. In this way, time and labor costs can be reduced, thereby improving the efficiency and effectiveness of image generation.

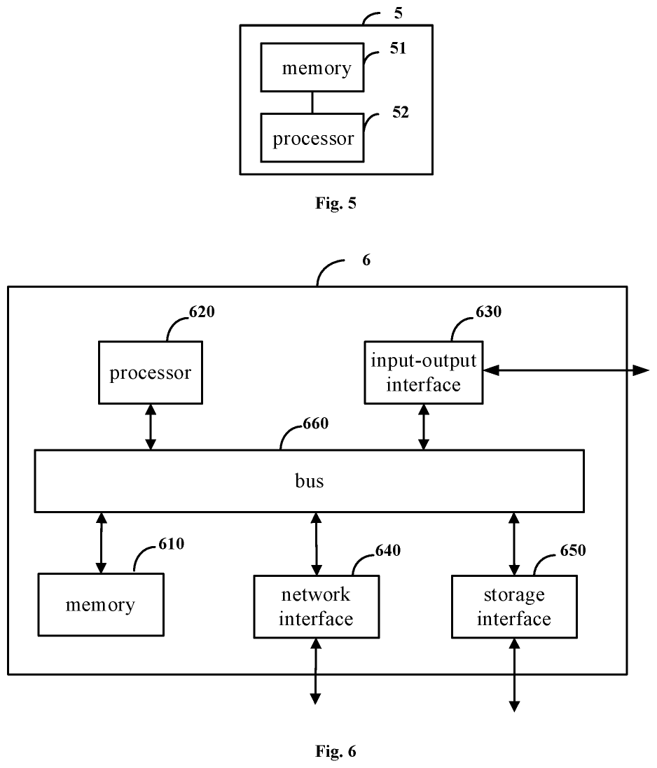

FIG. 5 shows a block diagram of an image generation apparatus according to other embodiments of the present disclosure.

As shown in FIG. 5, the image generation apparatus 5 of this embodiment includes: a memory 51 and a processor 52 coupled to the memory 51, the processor 52 configured to, based on instructions stored in the memory 51, carry out the image generation method according to any one of the embodiments of the present disclosure.

Where, the memory 51 may include, for example, a system memory, a fixed non-transitory storage medium, or the like. The system memory stores, for example, an operating system, applications, a boot loader, a database, and other programs.

FIG. 6 shows a block diagram of an image generation apparatus according to still other embodiments of the present disclosure.

As shown in FIG. 6, the image generation apparatus 6 of this embodiment includes: a memory 610 and a processor 620 coupled to the memory 610, the processor 620 configured to, based on instructions stored in the memory 610, carry out the image generation method according to any one of the foregoing embodiments.

The memory 610 may include, for example, a system memory, a fixed non-transitory storage medium, or the like. The system memory stores, for example, an operating system, application programs, a boot loader, and other programs.

The image generation apparatus 6 may further include an input-output interface 630, a network interface 640, a storage interface 650, and the like. These interfaces 630, 640, 650, the memory 610 and the processor 620 may be connected through a bus 660, for example. Where, the input-output interface 630 provides a connection interface for input-output devices such as a display, a mouse, a keyboard, a touch screen, a microphone, a loudspeaker, etc. The network interface 640 provides a connection interface for various networked devices. The storage interface 650 provides a connection interface for external storage devices such as an SD card and a USB flash disk.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical memory, etc.) having computer-usable program code embodied therein.

Heretofore, the image generation method, the image generation apparatus, and the non-transitory computer-readable storage medium according to the present disclosure have been described in detail. In order to avoid obscuring the concepts of the present disclosure, some details known in the art are not described. Based on the above description, those skilled in the art can understand how to implement the technical solutions disclosed herein.

The method and system of the present disclosure may be implemented in many ways. For example, the method and system of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which include machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. An image generation method, comprising:
receiving a first set of attribute information of a virtual object input by a user; and
generating a relevant image of the virtual object based on the first set of attribute information and an object template, wherein the object template matches the first set of attribute information and is configured to determine at least one of pose information and composition information of the virtual object in the relevant image.

2. The image generation method according to claim 1, wherein the object template is prioritized over the first set of attribute information, in response to a conflict between the first set of attribute information and the object template.

3. The image generation method according to claim 2, wherein the generating the relevant image of the virtual object based on the first set of attribute information and the object template comprises:
masking attribute information, in response to the attribute information conflicting with the object template in the first set of attribute information; and
generating the relevant image based on a masking result and the object template.

4. The image generation method according to claim 1, wherein the generating the relevant image of the virtual object based on the first set of attribute information and the object template comprises:
generating the relevant image based on first attribute information, the object template and a second set of attribute information stored, wherein the second set of attribute information is configured to indicate a designated requirement for the relevant image, and the second set of attribute information is prioritized over the first set of attribute information, in response to a conflict between the first set of attribute information and the second set of attribute information.

5. The image generation method according to claim 4, wherein the second set of attribute information comprises negative attribute information,
and the generating the relevant image based on the first attribute information, the object template and the second set of attribute information stored comprises:
masking attribute information, in response to the attribute information conflicting with the negative attribute information in the first set of attribute information; and
generating the relevant image based on a masking result and the second set of attribute information.

6. The image generation method according to claim 4, wherein the second set of attribute information comprises positive attribute information configured to improve image quality of the relevant image.

7. The image generation method according to claim 4, wherein the second set of attribute information is invisible to the user, and/or
the second set of attribute information is configured to indicate an image style type of the relevant image.

8. (canceled)

9. The image generation method according to claim 1, wherein the generating the relevant image of the virtual object based on the first set of attribute information and the object template comprises:
generating the relevant image based on an image style type selected by the user.

10. The image generation method according to claim 1, wherein the generating the relevant image of the virtual object based on the first set of attribute information and the object template comprises:
generating a plurality of candidate images based on the first set of attribute information, wherein a resolution of the plurality of candidate images is lower than a threshold; and
performing a super-resolution process on a selected candidate image in response to a user selection operation on the plurality of candidate images to generate the relevant image, wherein a resolution of the relevant image is higher than the resolution of the plurality of candidate images.

11. The image generation method according to claim 1, further comprising:
determining dynamic information of the virtual object in the relevant image based on content information corresponding to the relevant image, wherein the virtual object comprises a character object; and
generating, based on the dynamic information, a dynamic image of the character object by using a digital human model based on the relevant image.

12. The image generation method according to claim 11, wherein the generating, based on the dynamic information, the dynamic image of the character object by using the digital human model based on the relevant image comprises:
adjusting a facial angle of the character object in the relevant image based on the dynamic information; and
generating the dynamic image based on an adjusted relevant image.

13. The image generation method according to claim 1, wherein the virtual object comprises a character object, and the pose information is configured to indicate that a face of the character object in the relevant image is facing the user, with an eye of the character object directed toward the user.

14. The image generation method according to claim 1, wherein the generating the relevant image of the virtual object based on the first set of attribute information and the object template comprises:
determining the object template from a plurality of candidate object templates, in response to a user selection operation on the plurality of candidate object templates, wherein the plurality of candidate object templates match the first set of attribute information.

15. The image generation method according to claim 14, wherein the relevant image corresponds to a current frame image of interactive multimedia content, and the object template is selected based on content to be represented by the current frame image.

16. The image generation method according to claim 1, further comprising:
identifying a facial region of a character object in the relevant image, in response to the virtual object comprising the character object; and
segmenting the relevant image based on the facial region to generate a head portrait of the character object.

17. The image generation method according to claim 1, wherein a portion of the relevant image other than the virtual object is transparent,
and the image generation method further comprises:
fusing the relevant image with a background image to generate a frame image of interactive multimedia content.

18. The image generation method according to claim 1, further comprising:
segmenting an image region in which the virtual object is located from the relevant image; and
fusing the image region with a background image to generate a frame image of interactive multimedia content.

19. The image generation method according to claim 1, wherein the virtual object comprises a character object and a background object, and the composition information comprises at least one of position information and size information of the virtual object in the relevant image.

20. (canceled)

21. An image generation apparatus, comprising:
a memory; and
a processor coupled to the memory, the processor configured to, based on instructions stored in the memory, perform an image generation method comprising:
receiving a first set of attribute information of a virtual object input by a user; and
generating a relevant image of the virtual object based on the first set of attribute information and an object template, wherein the object template matches the first set of attribute information and is configured to determine at least one of pose information and composition information of the virtual object in the relevant image.

22. A non-transitory computer readable storage medium stored thereon a computer program that, when executed by a processor, performs an image generation method comprising:
receiving a first set of attribute information of a virtual object input by a user; and
generating a relevant image of the virtual object based on the first set of attribute information and an object template, wherein the object template matches the first set of attribute information and is configured to determine at least one of pose information and composition information of the virtual object in the relevant image.

23. (canceled)
